(19) United States
(12) Patent Application Publication
(10) Pub. No.: US 2022/0228089 A1
(43) Pub. Date: Jul. 21, 2022

(54) PEROXIDE COMPOSITION

(71) Applicant: Reckitt Benckiser Vanish B.V., Hoofddorp (NL)

(72) Inventors: Karol BRZOSKA, Mira (IT); Enrico GIUSTO, Mira (IT); Anna MARCHIANI, Mira (IT); Elisabetta PIERANGELO, Mira (IT); Simone SCOIZZATO, Mira (IT); Luca SPADONI, Mira (IT); Alessandro ZOTTI, Mira (IT)

(73) Assignee: Reckitt Benckiser Vanish B.V., Hoofddorp (NL)

(21) Appl. No.: 17/056,603

(22) PCT Filed: Apr. 18, 2019
(86) PCT No.: PCT/GB2019/051108

§ 371 Date: Nov. 18, 2020

(30) Foreign Application Priority Data
May 21, 2018 (GB) 1808297.4

(51) Int. Cl. C11D 3/39; C11D 1/83; C11D 3/22; C11D 11/00; C11D 17/00

(52) U.S. Cl. CPC C11D 3/3932; C11D 1/83; C11D 17/003; C11D 11/0035; C11D 11/0017; C11D 3/222

(57) ABSTRACT

A shelf stable laundry or hard surface composition comprising hydrogen peroxide is disclosed. The composition can be in the form of a thickened liquid or a gel that can support solid particles and is stable over a normal product shelf life against both precipitation of the particles and degradation of the peroxide and can tolerate a wide range of additional cleaning ingredients.

The invention relates to a new peroxide cleaning composition. The composition is particularly suited for the cleaning of soiled laundry and related fabric items. The composition may also be used to clean hard surfaces, including tableware in an automatic dishwasher. The compositions are aqueous based compositions.

Oxygen based bleach is widely used in domestic cleaning products for clothes and hard surfaces. This is due to its much less corrosive and surface damaging properties in comparison with chlorine bleach.

Due to the lack of stability of liquid peroxide (high reactivity) in combination with other detergent ingredients, oxygen bleach precursors are commonly used of peroxide in the detergent industry. These are broken down in situ to release hydrogen peroxide.

The most common bleach precursor is sodium percarbonate. This is solid and, if kept dry, fairly stable allowing it to be mixed with a wide variety of common detergent composition components. The majority of detergents using oxygen bleach cleaning utilise sodium percarbonate as a source of oxygen bleach.

Despite its effectiveness, sodium percarbonate still has drawbacks. The percarbonate needs to break down to release the peroxide and this is a highly temperature dependent reaction. With household energy use (due to a desire to limit damage to the environment) being an increasingly important concern, reduced washing temperatures are offered on all new domestic cleaning machines. Where once 60° C. washing was standard, now 30-40° C. cleaning temperatures are encouraged. The reduced temperatures make the breakdown of the percarbonate happen much more slowly, reducing the effectiveness of the bleaching. Catalysts can be added to the detergent compositions to assist this process at lower temperatures, but they are an additional cost and waste.

It is therefore an object of the present invention to formulate a stable product utilising hydrogen peroxide itself as the source of oxygen bleach.

Furthermore, there is a general consumer trend towards the use of new product formats, such as gels and/or products wrapped with water-soluble film, at the expense of traditional formats such as powder.

There is therefore a consumer need for gels or thickened liquids with both strong performance and a positive aesthetic appearance. The use of suspended particles in such a gel or thickened liquid both improves the aesthetic appearance of such a product and conveys technical efficacy.

it is therefore an object of the present invention to provide a formula that has the ability to achieve a stable suspension of solid particles avoiding both precipitation and degradation over shelf-life.

The applicants have surprisingly found an aqueous formulation of peroxide and surfactants that remains both potent and stable for a significant period of time. The formulation utilises micro-fibrous cellulose (MFC) to stabilise the composition. The composition can accommodate a wide range of different detergent chemistry and, most advantageously, can support suspended particles.

In a first aspect of the present invention there is provided a shelf stable laundry or hard surface composition comprising;
a) from 0.1 to 25% by weight of hydrogen peroxide
b) from 0.1 to 35% by weight of surfactants
c) from 0.1 to 80% by weight of water, and
d) from 0.1 to 20% by weight of micro-fibrous cellulose.

In a further embodiment the composition may be a thickened liquid or a gel.

The compositions of the invention are preferably laundry additives for the removal of stains (e.g. suitable for pre-treatment and/or use alongside detergent), but may also be utilised as detergents.

In a further embodiment the composition comprises suspended particles. Preferably, between 0.001 and 20% by weight of suspended particles, preferably between 0.005 and 10% by weight and most preferably between 0.01 and 5%, or even 0.01 and 1% by weight of suspended particles.

Advantageously, the suspended particles are not made from plastics and/or are biodegradable.

The compositions of the invention comprise one or more surfactants. The surfactant may comprise a nonionic, anionic, cationic, amphoteric or zwitterionic surface active agents or suitable mixtures thereof may be used. Many such suitable surfactants are described in Kirk Othmer's Encyclopaedia of Chemical Technology, 3rd Ed., Vol. 22, pp. 360-379, “Surfactants and Detersive Systems”. In general, oxygen bleach-stable surfactants are preferred according to the present invention.

In a further embodiment the surfactants comprise nonionic surfactants or anionic surfactants or mixtures thereof.

Suitably a surfactant when present is a nonionic surfactant, suitably a C6-18 (preferably C12-15) primary or secondary linear or branched alcohol condensed with an alkylene oxide, preferably with an average 3-8 moles of the alkylene oxide per mole of fatty alcohol. The preferred alkylene oxide is ethylene oxide.

One other possible class of nonionic surfactants are ethoxylated nonionic surfactants prepared by the reaction of a monohydroxy alkanol or alkylphenol with 6 to 20 carbon atoms with at least 3 moles, preferably at least 6 moles, more preferably at least 9 moles, further preferably at least 12 moles, particularly preferably at least 16 moles, and still more preferably at least 20 moles of ethylene oxide per mole of alcohol or alkylphenol.

Other possible nonionic surfactants are the nonionics from a linear chain fatty alcohol with 16-20 carbon atoms and at least 12 moles particularly preferred at least 16 and still more preferred at least 20 moles of ethylene oxide per mole of alcohol.

Suitable anionic surfactants include any conventional anionic surfactant or a mixture of them used in detergent products. These include, for example, the alkyl benzene sulphonic acids and their salts as well as alkoxylated or non-alkoxylated alkyl sulphate materials. The anionic surfactants may be present in acid form or in neutralized (e.g., salt) form. The anionic surfactants may be linear, branched, or a mixture thereof.

Exemplary anionic surfactants are sulphonic-acid based surfactants. For example, the alkali metal salts of CurC alkyl benzene sulphonic acids or Cn-C14 alkyl benzene sulphonic acids. In some aspects, the alkyl group is linear, and such linear alkyl benzene sulfonates are known as “LAS.” Alkyl benzene sulfonates, and particularly LAS, are well known in the art. Such surfactants and their preparation are described in, for example, U.S. Pat. Nos. 2,220,099 and 2,477,383. Especially useful are the sodium and potassium linear straight chain alkylbenzene sulfonates in which the average number of carbon atoms in the alkyl group is from about 10 to about 14. Sodium Cn-C14, e.g., C12, LAS is a specific example of such surfactants. Another exemplary type of anionic surfactant is alkoxylated alkyl sulphate surfactants. Preferred are ethoxylated alkyl sulphate surfactants. Such materials are also known as alkyl ether sulphates, alkyl polyethoxylate sulphates, or simply “AES,” and correspond to the formula: R′—O—(C2H40)n—SO3M, where R′ is a C8-C20 alkyl group; n is from about 0.5 to about 20, or from about 1 to about 20; and M is a salt-forming cation. In one aspect, R′ is a CurC alkyl; n is from about 1 to about 15; and M is sodium, potassium, ammonium, alkylammonium, or alkanolammonium. In one aspect, R′ is a C12-C16 alkyl; n is from about 0.5 to about 6, or from about 1 to about 6; and M is sodium.

Alkyl ether sulphates are generally available in the form of mixtures comprising varying R′ chain lengths and varying degrees of ethoxylation. Frequently such mixtures also contain some non-ethoxylated alkyl sulphate (“AS”) materials, i.e., surfactants of the above ethoxylated alkyl sulphate formula where n=0.

Non-ethoxylated alkyl sulphates may also be added separately to the compositions of the invention. Specific examples of non-alkoxylated alkyl ether sulphate surfactants are those produced by the sulfation of higher C8-C20 fatty alcohols. Conventional primary alkyl sulphate surfactants have the general formula: ROS03-M+ where R is a linear C8-C20 hydrocarbyl group and M is a water-solubilizing cation. In one aspect, R is a CKTQS alkyl and M is alkali metal, more specifically R is C12-C14 and M is sodium.

In a further embodiment the surfactants comprise between 1 and 30% by weight, preferably 5 and 25% by weight, more preferably 7.5 and 22.5% by weight and most preferably between 10 and 20% by weight of the composition.

In a further embodiment the ratio of nonionic surfactants to anionic surfactants ranges from 5:1 to 1:5, preferably 3:1 to 1:3 and most preferably from 2:1 to 1:2, such as 2:1 to 1:1.

The one or more nonionic surfactant is/are preferably present in an amount of between 2 and 20%, such as between 4 and 18%, or 5 and 15%.

The one or more anionic surfactants is/are preferably present in an amount of between 1 and 15%, such as between 3 and 12%, or 4 and 10%.

In a further embodiment of the invention the hydrogen peroxide comprises between 1 and 20% by weight, more preferably 3 and 18% by weight, more preferably 3 and 15% by weight, more preferably 5 and 14%, such as 6 and 14%, more preferably 5 and 12.5%, and most preferably 7 and 12% by weight of the composition.

Hydrogen peroxide is normally supplied in a 50% by weight solution in water.

In a further embodiment, the composition comprises between 5 and 75% by weight, preferably between 20 and 70% by weight, such as between 30 and 70%, between 40 and 70%, or between 50 and 70% by weight of water. Alternatively, the composition comprises between 20 and 65% by weight, most preferably between 30 and 50% by weight water.

The water concentration in the formula can be adjusted to increase or decrease both the concentration of the cleaning solution and its viscosity.

The composition of the present invention utilises micro-fibrous cellulose (MFC) as a thickener/stabiliser/suspending agent.

By MFC it is meant herein cellulose, with micro or nano fibrils. The cellulose fibres can be of bacterial or botanical origin, i.e. produced by fermentation or extracted from vegetables, plants, fruits or wood. Cellulose fibre sources may be selected from the group consisting of citrus peek, such as lemons, oranges and/or grapefruit; fruits, such as apples, bananas and/or pear; vegetables such as carrots, peas, potatoes and/or chicory; plants such as bamboo, jute, abaca, flax, cotton and/or sisal, cereals, and different wood sources such as spruces, eucalyptus and/or oak. Preferably, the cellulose fibres source may be selected from the group consisting of wood or jute. The content of cellulose will vary depending on the source and treatment applied for the extraction of the fibres, and will range from 15 to 100%, preferably above 30%, more preferably above 50%, and even more preferably above 80%.

Such cellulose fibres may comprise pectin, hemicellulose, proteins, lignin and other impurities inherent to the cellulose based material source such as ash, metals, salts and combinations thereof.

The cellulose fibres are preferably nonionic.

MFC is also known as reticulated cellulose or as micro fibrillated cellulose, which may be produced by fermentation of Acetobacter xylinum. These bacteria produces cellulose that is chemically identical to plant-derived cellulose. Though identical in chemical structure, MFC fibres may be smaller in diameter than plant-derived cellulose fibres, thereby giving MFC a greater surface area. This high surface area allows MFC to create three-dimensional networks that produce a desirable yield value in solution at low use levels. MFC is essentially insoluble and uncharged and, therefore, may not be not adversely affected by ionic environments. Because MFC is essentially insoluble it does not compete for water and, therefore, has a wide range of compatibility and is much less susceptible to degradation than water-soluble polysaccharides. It is compatible with both concentrated anionic aqueous solutions, such as heavy brines used in oilfield applications, and in high surfactants systems, such as liquid dish and laundry detergents (see, e.g., U.S. Published Patent Applications 2008/0108541.

A method of making MFC is discloses in WO 2013154675 A1, the contents of which are enclosed by reference.

Such fibres are commercially available, for instance Citri-Fi 100FG from Fiberstar, Herbacel® Classic from Herbafood, and Exilva® from Borregaard.

In a further embodiment of the invention the micro-fibrous cellulose is supplied in liquid suspension form.

A particularly preferred grade of MFC for the composition of the present invention is Cellulon L27® produced by CP Kelco. Other possible grades of MFC from this supplier include Cellulon L88® and Cellulon L93®.

In a further embodiment of the invention the pH of the composition is less than 7. Peroxide is generally more stable in acidic environments. The pH is preferably between 3 and 6.

The composition of any of the previous claims wherein the composition has a viscosity of at least 20 cps at 25° C., preferably at least 500 cps at 25° C., more preferably at least 1000 cps at 25° C.

The preference is for the compositions of the present invention to be thickened. This allows for greater stability of the peroxide and a greater suspending ability of the composition to support particles. The thickness may be increased by adjusting the amount of water and MFC in the composition.

Examples of the viscosities of common materials is given below:

Approximate Viscosities of Common Materials
(At Room Temperature-25° C.)

| Material | Viscosity in Centipoise | |
|---|---|---|
| Water | 1 | cps |
| Milk | 3 | cps |
| SAE 10 Motor Oil | 85-140 | cps |
| SAE 20 Motor Oil | 140-420 | cps |
| SAE 30 Motor Oil | 420-650 | cps |
| SAE 40 Motor Oil | 650-900 | cps |
| Castrol Oil | 1,000 | cps |
| Karo Syrup | 5,000 | cps |
| Honey | 10,000 | cps |
| Chocolate | 25,000 | cps |
| Ketchup | 50,000 | cps |
| Mustard | 70,000 | cps |
| Sour Cream | 100,000 | cps |
| Peanut Butter | 250,000 | cps |

In a further embodiment the composition may further comprise an additional thickening agent to obtain the required flow/viscosity characteristics.

In a further embodiment the composition comprises xanthan gum, guar gum, gelatin, aginates, agar, locust bean gum, carrageenan and mixtures thereof as an additional thickener.

In a further embodiment the additional thickening agent comprises between 0.1 and 10% by weight of the composition, preferably between 0.2 and 5% and most preferably between 0.5 and 3% by weight of the composition.

In a further embodiment the composition thickened sufficiently to form a solid self-supporting gel. This may allow monodose gel portions to be used. These may be wrapped in a protective film, such as PVOH (polyvinyl alcohol) prior to use.

The suspended particles may be actives incompatible with peroxide. These may be encapsulated or coated if the chemistry interacts with the peroxide. But this may not be required depending on the thickness of the liquid or gel. The particles may also simply be decorative.

A second aspect of the present invention is a method of cleaning soiled items of clothing or other fabrics comprising adding between 10 g and 200 g of a composition according to the first aspect of the present invention to a collection of soiled clothing or fabrics in an automatic washing machine and carrying out a wash cycle.

In a further embodiment that composition is added to the soiled clothing or fabrics prior to the commencement of the wash cycle. Alternatively, or additionally, the composition of the first aspect of the invention is added to the soiled clothing or fabrics during the wash cycle.

In a third aspect of the present invention there is the use of the composition of the first aspect of the invention to clean soiled fabric items.

In addition to the features listed before, the following non-limiting optional ingredients may be used in the compositions of the present invention. These may be found in the liquid or gel portion or in the optional suspended particles as required.

Suitable laundry adjuncts are further described, for example, in U.S. patent application Ser. No. 13/623,128, incorporated herein by reference.

For example, builders may be added to any of the compositions used. The builder may be either a phosphate builder or a phosphate-free builder, but is preferably phosphate-free. Preferably it is chosen from amino acid based compounds and/or succinate based compounds. The terms ‘succinate based compound’ and ‘succinic acid based compound’ are used interchangeably herein.

Conventional amounts of the amino acid based compound and/or succinate based compound may be used for composition of the present method. Preferred examples of amino acid based compounds which may be used are MGDA (methyl-glycine-diacetic acid, and salts and derivatives thereof) and GLDA (glutamic-N,N-diacetic acid and salts and derivatives thereof).

Preferred examples include tetrasodium imminosuccinate. Iminodisuccinic acid (IDS) and (hydroxy)-iminodisuccinic acid (HIDS) and alkali metal salts or ammonium salts thereof are especially preferred succinate-based builder salts.

It is preferred according to the present invention that the builder comprises methyl-glycine-diacetic acid, glutamic-N,N-diacetic acid, tetrasodium imminosuccinate, or (hydroxy)-iminodisuccinic acid and salts or derivatives thereof.

Another preferred builder is 2-(I-Carboxy-ethoxy)-2-methyl-malonic acid. Other builders include non-polymeric organic molecules with carboxylic group(s). Builder compounds which are organic molecules containing carboxylic groups include citric acid, fumaric acid, tartaric acid, maleic acid, lactic acid and salts thereof. In particular, the alkali or alkaline earth metal salts of these organic compounds may be used, and especially the sodium salts. An especially preferred phosphorous-free builder is sodium citrate. Such polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Such polycarboxylates which contain three carboxyl groups include, for example, water-soluble citrate. Correspondingly, a suitable hydroxycarboxylic acid is, for example, citric acid.

The compositions may comprise a preservative. Suitable preservatives may be selected by one of ordinary skill in the art and may include Proxel™ (available from Arch Chemicals/Lonza). The composition may comprise from about 0.01 percent to about 2.0 percent, or about 0.1 percent to about 1.0 percent, or about 0.1 percent to about 0.3 percent, by weight of the composition, of preservative. In some aspects, the compositions comprise less than 0.01 percent of a preservative. In some aspects, the compositions are substantially free of preservatives.

The compositions may comprise clay soil removal/anti-redeposition agents, such as water-soluble ethoxylated amines. Other exemplary clay soil removal and anti-redeposition agents are described in U.S. Pat. Nos. 4,597,898; 548,744; 4,891,160; European Patent Application Nos. 111,965; 111,984; 112,592; and WO 95/32272. In some aspects, the concentrated compositions comprise about 0.005 percent to about 5 percent by weight of clay soil removal/anti-redeposition agents. In some aspects, the composition is substantially free of clay soil removal/anti-redeposition agents.

The compositions may comprise from about 0.001 percent to about 0.5 percent by weight of the composition of soil suspension polymers. Soil suspension polymers include, without limitation, PEI ethoxylates, HMDA diquat ethoxylates, sulfonated derivatives, and hydrophobically modified anionic copolymers.

The compositions may comprise from about 0.001 percent to about 1 percent by weight of the composition of soil release polymers. Soil release polymers include, without limitation, a PET alkoxylate short block copolymer, an anionic derivative thereof, or mixtures thereof.

The compositions may comprise from about 0.00001 percent to about 0.1 percent by weight active enzymes that are stable and effective in a low-pH environment. Suitable enzymes include carbohydrase, pectinase, mannase, amylase, cellulase, lipase, protease, or mixtures thereof.

The compositions may comprise dye transfer inhibitors and/or dye fixatives. Examples of dye transfer inhibitors useful herein include polyvinylpyrrolidone, poly-4-vinylpyridine-N-oxide, copolymers of N-vinyl-2-pyrrolidone and N-vinylimidazole, or mixtures thereof. Useful dye fixatives for this application are disclosed in U.S. Pat. No. 6,753,307.

The compositions may comprise a fabric softening additive. Examples of fabric softening additives useful herein include alkyl quaternary ammonium compounds, ester quaternary ammonium compounds, silicones, cationic silicones, or mixtures thereof.

The compositions may comprise a chelant. Chelants useful herein include DTPA, HEDP, DTPMP, polyfunctionally-substituted aromatic chelants (such as I,2-dihydroxy-3,5-disulfobenzene (Tiron)), dipicolinic acid, and mixtures thereof, preferably HEDP. Where such components are present, they may be present in amounts of between 0.01 and 5%, such as between 0.1 and 3%, or even between 0.1 and 1%.

The compositions may comprise a radical scavenger which may be used with liquid hydrogen peroxide to provide stability. Radical scavengers useful herein include trimethoxybenzoic acid or butylated hydroxytoluene (BHT). These compounds may be present in an amount of between 0.001 and 5%, such as between 0.005 and 2%, or 0.01 and 1%.

The compositions of the present invention may comprise perfume. The perfume is typically an acid- stable perfume. The compositions may comprise from about 0.1 percent to about 5 percent, or from 0.15 to about 4 percent or from about 0.5 percent to about 4 percent, or from about 1 percent to about 3 percent, or from about 2 percent to about 2.5 percent, by weight of the composition, of perfume.

The compositions may comprise a fluorescent whitening agent. Fluorescent whitening agents useful herein include those that are compatible with an acidic environment, such as Tinopal CBS-X®.

The compositions may comprise suds suppressor. In some aspects, the compositions comprise from about 0.001 percent to about 0.02 percent, by weight of the composition, of suds suppressor. Examples of suds suppressors useful herein include silica/silicone type, silicone oil, branched alcohols, or mixtures thereof.

It is intended that all described features can be combined with one or more other features in any combination. All percentages are by weight unless otherwise specified. All references to ‘between’ and percentages are intended to include the stated end points and so are equivalent to ‘from’ and ‘to’.

The invention is demonstrated by the following non-limited Examples.

### EXAMPLES

Viscoelasticity

Rheology is the study of the flow of matter, primarily in a liquid state, but also as “soft solids” or solids under conditions in which they respond with plastic flow rather than deforming elastically in response to an applied force. Resistance to deformation (expressed as G* module, |G*| [Pa]) and elasticity (expressed as phase angle, δ1 [°]) are used to study the viscoelasticity of the tested formulations.

Ideal conditions for suspension are high elasticity (i.e. low δ1) and high stiffness (i.e. high resistance to deformation hence high |G*|). However, too high elasticity or stiffness can play a negative role in the situation where a pourable gel is the targeted functionality. Thus, in order to achieve pourable liquid, elasticity and stiffness need to be balanced.

OSC Stress Sweep Test

Two compositions (Formulae A and B) according to the invention and comprising the suspending agent (MFC) were tested and compared to two compositions (Formulae C and D) without the suspending agent.

TABLE 1

| Ingredients | A | B | C | D |
|---|---|---|---|---|
| Water | 53.625 | 54.69 | 59.07 | 60.685 |
| Suspending agent | 5 | 4 | 0 | 0 |
| Surfactants | 18 | 18 | 18.85 | 20.29 |
| HEDP | 0.2 | 0.2 | 0.2 | 0.2 |
| H₂O₂ (50%) | 20 | 20 | 18 | 16 |
| Auxiliary | 3.175 | 3.11 | 3.88 | 2.825 |

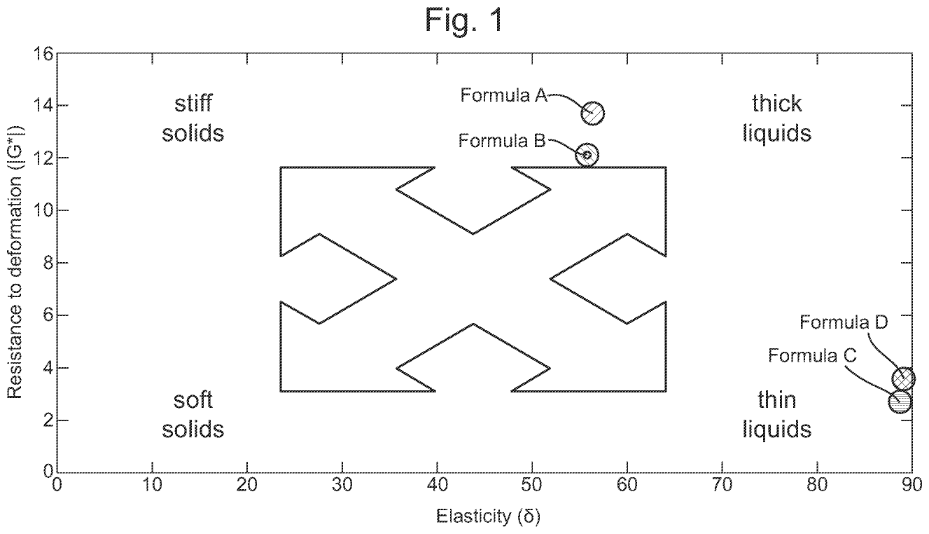

A stress ramp from very low stress (at rest, e.g. on the shelf) to high stress (flowing, e.g. pouring) in oscillatory mode was applied to the samples and the Resistance to Deformation |G*| and the Phase Angle (Elasticity) δ was measured (|G*| and δ being the two components of the viscoelasticity). The results are set out in Table 2 and plotted in FIG. 1.

Instrument Setting

Measuring Device: RS1 (RheoStress RS1)

Temperature Device: DC50 (manual settings)

Measuring Geometry: PP60 Ti LO09 002 (Crosshatched Plate-Plate)− [symbol] =60 mm−Gap=1.0 mm

Test temperature=25 ° C. and 60 ° C.

TABLE 2

| Formulae | \|G*\| | δ |
|---|---|---|
| A (Invention) | 13.7 | 56.4 |
| B (Invention) | 12.1 | 55.8 |
| C (Comparative) | 2.7 | 88.7 |
| D (Comparative) | 3.6 | 89.1 |

As shown in Table 2 and FIG. 1, Formulae C and D show poor elasticity and poor resistance to deformation, therefore the conditions do not permit particles to remain suspended through a product's shelf-life.

Formulae A and B show higher elasticity and higher resistance to deformation vs. Formulae C or D, and thus have the ability to suspend speckles.

Sedimentation

To confirm the findings of the viscoelasticity experiments, compositions with (Formula E) and without the suspending agent (Formula F) were tested for their suspensive properties.

TABLE 3

| Ingredients | E | F |
|---|---|---|
| Water | 54.69 | 58.69 |
| Suspending agent | 4 | 0 |
| Surfactants | 18 | 18 |
| HEDP | 0.2 | 0.2 |
| H₂O₂ (50%) | 20 | 20 |
| Auxiliary | 3.11 | 3.11 |

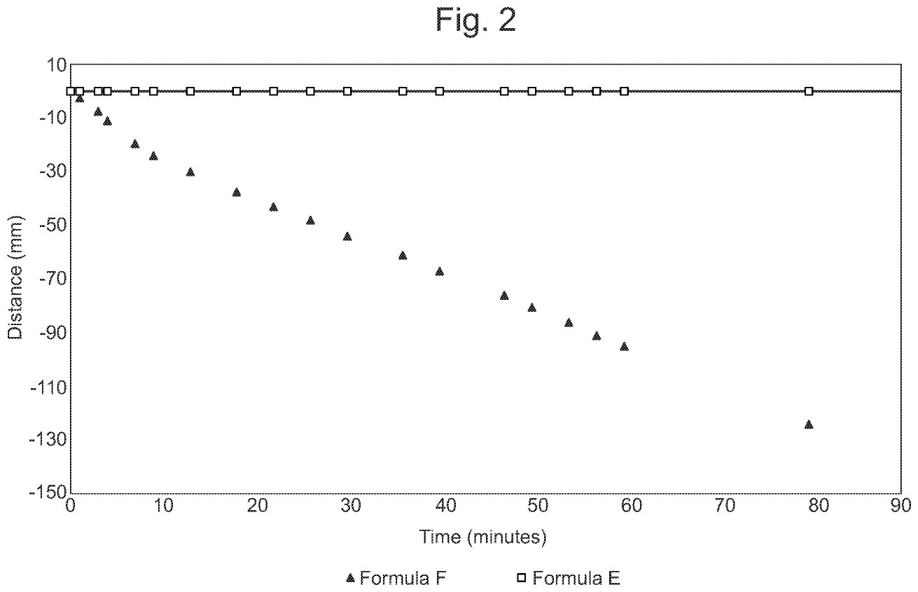

The two compositions were decanted into a 100 mL measuring cylinder with a particle added at t=0. The distance that the speckle travels down the measuring cylinder was then measured at regular time intervals. The results are presented in Table 4 and plotted in FIG. 2.

TABLE 4

| Time | Dropping distance (mm) | |
|---|---|---|
| (minutes) | Formula F | Formula E |
| 0 | 0 | 0 |
| 1 | 2.5 | 0 |
| 3 | 7.5 | 0 |
| 4 | 11 | 0 |
| 7 | 19.5 | 0 |
| 9 | 24 | 0 |
| 13 | 30 | 0 |
| 18 | 37.5 | 0 |
| 22 | 43 | 0 |
| 26 | 48 | 0 |
| 30 | 54 | 0 |
| 36 | 61 | 0 |
| 40 | 67 | 0 |
| 47 | 76 | 0 |
| 50 | 80.5 | 0 |
| 54 | 86 | 0 |
| 57 | 91 | 0 |
| 60 | 95 | 0 |
| 80 | 124 | 0 |

No particle sedimentation is observed for the compositions of the present invention, while the comparative composition demonstrates a significant quantity of sedimentation.

Stability

The long-term stability of a composition according to the present invention (Formula G) was tested at a variety of temperatures and humidity.

TABLE 5

| Formula G | % |
|---|---|
| Water | 66.654 |
| Suspending agent | 4 |
| Surfactants | 18 |
| HEDP | 0.12 |
| H₂O₂ | 10 |
| Suspended particles | 0.035 |
| Auxiliary | 1.191 |

The colour and appearance of the compositions were visually ranked from 1 to 5 in terms of the difference from the colour and appearance (such as particle dispersion) at the beginning of the trial. The results are set out in Table 6.

TABLE 6

| | | | | |
|---|---|---|---|---|
| Weeks | Viscosity (cP) | pH | Colour | Appearance |

5 ± 2° C. Ambient Humidity

| | | | | |
|---|---|---|---|---|
| 0 | 1593 | 4 | 1 | 1 |
| 1 | 1653 | 4.1 | 1 | 1 |
| 3 | 1668 | 4.2 | 1 | 1 |
| 6 | 1749 | 4.1 | 1 | 1 |
| 9 | 1654 | 4.1 | 1 | 1 |
| 12 | 1796 | 4.2 | 1 | 1 |

25 ± 2° C. Ambient Humidity

| | | | | |
|---|---|---|---|---|
| 0 | 1593 | 4 | 1 | 1 |
| 1 | 1719 | 4.1 | 1 | 1 |
| 3 | 1851 | 4.1 | 1 | 1 |
| 6 | 1734 | 4.1 | 1 | 1 |
| 9 | 1644 | 4.2 | 1 | 1 |
| 12 | 1762 | 4.2 | 1 | 1 |

30 ± 2° C. 65% Humidity

| | | | | |
|---|---|---|---|---|
| 0 | 1593 | 4 | 1 | 1 |
| 1 | 1701 | 4.1 | 1 | 1 |
| 3 | 1752 | 4.2 | 1 | 1 |
| 6 | 1674 | 4.2 | 1 | 1 |
| 9 | 1602 | 4.2 | 1 | 1 |
| 12 | 1700 | 4,3, | 1 | 1 |
| 18 | 1602 | 4.3 | 1 | 1 |

40 ± 2° C. 70% Humidity

| | | | | |
|---|---|---|---|---|
| 0 | 1593 | 4 | 1 | 1 |
| 1 | 1782 | 4.1 | 1 | 1 |
| 3 | 1770 | 4.2 | 1 | 1 |
| 6 | 1701 | 4.2 | 1 | 1 |
| 9 | 1618 | 4.2 | 1 | 1 |
| 12 | 1689 | 4.2 | 1 | 1 |
| 18 | 2274 | 4.2 | 1 | 1 |

The compositions of the present invention can be seen to demonstrate excellent stability in a range of environments.

The invention is defined by the claims.

1. A shelf stable laundry or hard surface cleaning composition comprising:
0.1-25% by weight of hydrogen peroxide;
0.1-35% by weight of surfactants;
0.1-80% by weight of water; and
0.1-20% by weight of micro-fibrous cellulose.

2. The composition of claim 1 wherein the composition is a liquid or a gel.

3. The composition of claim 1 further comprising suspended particles.

4. The composition of claim 3, wherein the particles are further actives incompatible with peroxide and/or surfactants.

5. The composition of claim 3, wherein the particles are decorative.

6. The composition of claim 1, wherein the surfactants comprise nonionic surfactants or anionic surfactants or mixtures thereof.

7. The composition of claim 1, wherein the composition comprises between 1 and 30% by weight surfactants.

8. The composition of claim 1, wherein the composition comprises between 1 and 20% by weight hydrogen peroxide.

9. The composition of claim 1, wherein the composition comprises between 5 and 70% by weight water.

10. The composition of claim 1, wherein the micro-fibrous cellulose is supplied in liquid form.

11. The composition of claim 1, wherein the micro-fibrous cellulose is Cellulon L27® cellulose.

12. The composition of claim 1, wherein the pH is less than 7.

13. The composition of claim 1, wherein the pH is between 3 and 6.

14. The composition of claim 1, wherein the composition has a viscosity of at least 20 cps at 25° C.

15. The composition of claim 1 further comprising an additional thickening agent.

16. The composition of claim 15, wherein the additional thickening agent comprises xanthan gum, guar gum, gelatin, alginates, agar, locust bean gum, carrageenan and mixtures thereof.

17. The composition of claim 15, wherein the additional thickening agent comprises between 0.1 and 10% by weight of the composition.

18. The composition of claim 1, wherein the composition is a solid self-supporting gel.

19. A method of cleaning soiled items of clothing or other fabrics comprising adding between 10 g and 200 g of the composition of claim 1 to a collection of soiled clothing or fabrics in an automatic washing machine and carrying out a wash cycle.

20. The method of claim 19, wherein the composition of claim 1 is added to the soiled clothing or fabrics prior to the commencement of the wash cycle.

21. The method of claim 19, wherein the composition of claim 1 is added to the soiled clothing or fabrics during the wash cycle.

22. A method of using the composition of claim 1 to clean soiled fabric items or hard surfaces.
